(19) United States
(12) Patent Application Publication
(10) Pub. No.: US 2004/0117776 A1
(43) Pub. Date: Jun. 17, 2004

(54) Type-specific objects from markup and web-oriented languages, and systems and methods therefor

(76) Inventor: Paul Pazandak, Bloomington, MN (US)

Correspondence Address: H. DALE LANGLEY, JR., THE LAW FIRM OF H. DALE LANGLEY, JR. PC, 610 WEST LYNN, AUSTIN, TX, 78703, US

(21) Appl. No.: 10/653,527

(22) Filed: Sep. 2, 2003

Related U.S. Application Data
(63) Continuation of application No. 09/247,209, filed on Feb. 9, 1999.

(51) Int. Cl. G06F 9/45

(52) U.S. Cl. 717/143; 717/114; 717/108

(57) ABSTRACT

A method of parsing XML creates type-specific objects for object-oriented applications. The method includes acquiring the XML, associating the XML with a call, calling a code, and creating a type-specific object from the XML because of the code. The association may be implicit or explicit. The type-specific object is an object-oriented object, for example, a Java™ object, a C⁺⁺ object, or some other object-oriented programming language class.

### BACKGROUND OF THE INVENTION

The present invention generally relates to parser instantiation of objects in computer software programming and, more particularly, relates to parsing of Markup Language documents to produce application-specific (also referred to as “type-specific”) objects in an Object-oriented Programming Language (OOPL), for example, parsing Extensible Markup Language (XML) documents to produce instantiated application-specific Java objects.

A “parser” is a computer program that receives input in the form of sequential source program instructions, interactive online commands, markup tags, or some other defined interface and breaks that input into parts, e.g., objects and attributes, that can be managed by other programming. Typically, a parser is part of a compiler which converts human readable software instructions into machine readable forms, for example, software source code into object code. Compilers usually first parse all of the human readable language statement instructions syntactically one after the other and then, in one or more successive passes, build output machine readable code, making sure that statements that refer to other statements are referenced correctly in the final machine code.

A variety of parsers and parsing methods are known to those skilled in the art. These parsers and methods are largely programming language specific and function according to any of several conventional parsing schemes. In order for conventional parser operation to be possible, the language instructions or other input to the parser must comprise language characteristics or other elements distinguishable to the parser, as to which the parser may respond with break up of the input in desired manner for use in other applications. As can be readily understood, then, if input instructions do not contain such distinguishable elements, parsing could not be possible.

The parsing effects or results which may be achieved in any instance are similarly dependent upon the elements of the input instructions which are distinguishable to the parser. If the input instructions contain only limited variability of distinction in the elements read by the parser, the parsing results will be limited to some categorization or arrangement consistent with the limitations in the variability. That is, if the parser only generically distinguishes between objects and attributes of a set of programming language instructions being parsed, then the parser results (regardless of the parser schema) will only reflect those three levels of distinction.

With the widespread adoption of object-oriented programming and programming languages, it is now possible with such programming and languages to define objects and their related characteristics in a wide variety of manners, as best suits the need of the programming environment and application. In general, the objects in such instances are the things you think about first in designing a program and they are also the units of code that are eventually derived from the process. In between, each object is made into a typed class of object and even super-typed classes are defined so that objects can share models and reuse the class definitions in their code. Each object is an instance of a particular class or subclass with the class's own methods or procedures and data variables. Within each of these levels, i.e., object, class, subclass, methods, and data variables, distinction and even additional levels of distinction are possible. Thus, parsing of descriptions of object-oriented features can provide highly categorized and classified levels and characteristics of distinction for use in further operations. Such parsing provides many advantages, as those skilled in the art will know and appreciate.

XML documents may themselves be considered as objects, for example, in the sense that application-specific behaviors can be associated with the XML data structure consistent with standard object-oriented programming principles. Conventional XML parsers provide the ability to parse XML documents describing XML objects. (As used herein in certain instances, references to XML objects, XML documents, XML files or XML are all intended to and should be construed as referring to any and all data or information conforming to XML standards.) These parsers, however, can only generate a generic object structure (i.e., a “parse tree”) representing a generic structuring of the object that was parsed (i.e., the structure of the XML document, in this case), without taking into account, for example, any behavior or structure that could have been originally associated with data contained in the XML object. The references to generic classes and objects herein have specific meanings. All conventional parsers have a set of classes that are used to instantiate XML. The classes so instantiated by conventional parsers, e.g., typically “Element” class and “Attribute” class only, are what are referred to herein as generic classes. These generic classes will not change based on the particular content of the XML. (Later herein, references are made to type-specific classes and objects, which are distinguished from generic classes and objects. Type-specific classes are any and all classes that are not merely generic classes, e.g., type-specific classes include, without limitation, Java™ classes, C⁺⁺ classes, smalltalk classes, CLOS classes, other object-oriented programming language classes, and different types of classes within each such language and combination of and among those classes.)

In essence, when the conventional XML parser encounters an XML element declaration, it merely instantiates a generic “Element” object. A result of a parse of an exemplary XML document may therefore be envisioned, for example purposes, as follows:

| | | |
|---|---|---|
| root | \|->Element | \|-> Element \|-> Element |
| | \| | \|-> Element |
| | \| | \|-> Element \|-> Element |
| | \| | |
| | \|->Element | \|-> Element {\|-> Element}* |
| | | \|-> Element {\|-> Element}* |
| | | \|-> Element {\|-> Element}* |
| | | \|-> Element {\|-> Element}* |

The resulting tree is a composition of generic Element objects having no structure or behavior specific to the XML object. With the conventional parse of an XML document, therefore, every single application of an XML document will need to supply its own code to understand how to navigate and interpret the generic Element structure, and possibly provide behavior for each Element. Thus, object-oriented concepts, in conventional XML document scenarios, are not possible.

Without any associated behaviors, the data found in the parse tree from parsing of the XML document can only be accessed by an application in one of two ways: (1) the application could traverse the tree structure node by node, extracting out and consuming the data as it progresses along the tree; or (2) the application could copy the data out of the generic tree structure and place it into a second, application-specific object structure containing associated behaviors—thereafter directly accessing the replicated data directly in this new structure. In both approaches, however, the application embeds the behavior information within itself, thereby making that information inaccessible and unusable to other applications. Consequently, each application that parses the original XML object would need to define its own behavior for those structures which, in turn, is a replication of effort across the set of applications that will in fact access the XML object.

It would, therefore, be a significant advantage and improvement in the art to provide systems and methods of parsing of XML documents to produce an application-specific output structure, comprised of type-specific classes which contain behaviors unique to each class consistent with object-oriented concepts.

### SUMMARY OF THE INVENTION

To this end, an embodiment of the invention is a method of parsing an XML document. The method includes defining type-specific object classes and associating the type-specific object classes with the XML document.

Another embodiment of the invention is a system of parsing an XML document. The system includes a computer capable of receiving the XML document, a code for operating the computer, means for calling the code, and a class declaration locatable by the code.

Yet another embodiment of the invention is a method of parsing an XML document. The method includes acquiring the XML document, associating the XML document with a call, calling a code, and creating a type specific object from the XML document because of the code.

Another embodiment of the invention is a method of generating type-specific objects from XML. The method includes calling a code that operates on XML, processing the code, locating type-specific class associations, locating the type-specific class code via the step of processing, acquiring the type-specific class code via the step of processing, and parsing the XML to obtain the type-specific objects, the step of parsing being dictated by the type-specific class declarations from the step of locating and according to a result of the step of processing.

Yet another embodiment of the inventions is a method of generating type-specific objects from a generic object. The method includes creating an XML document, defining type-specific object classes corresponding to the type-specific objects, associating the type-specific object classes with the XML document, parsing the XML document to instantiate the type-specific object classes, and obtaining the type-specific objects.

### BRIEF DESCRIPTION OF THE DRAWINGS

FIG. 1 is a flow diagram of a method of instantiation of type-specific objects by parsing XML documents, according to embodiments of the invention.

FIG. 2 is a system for performing the method of FIG. 1, according to embodiments of the invention.

### DETAILED DESCRIPTION

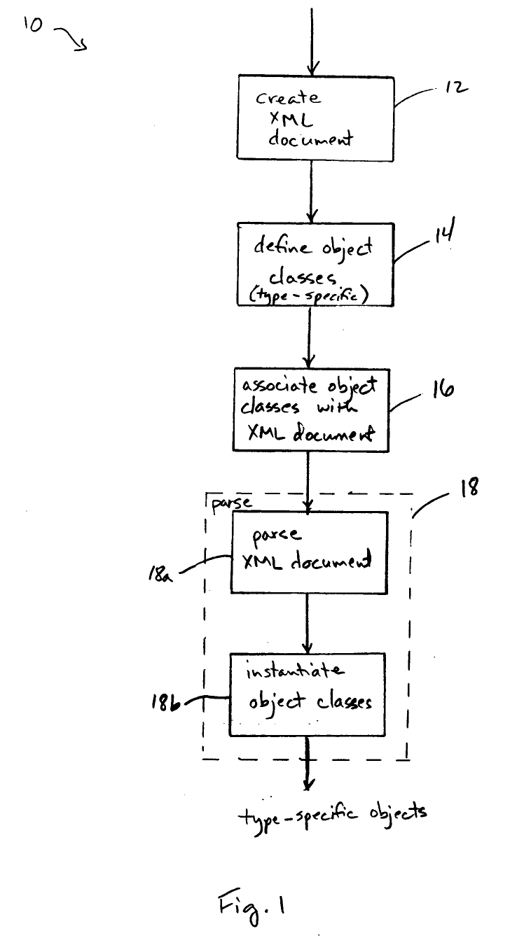

Referring to FIG. 1, a method 10 of creating type-specific objects from XML documents is commenced with a step 12 of creating an XML document. As those skilled in the art will know and appreciate, Extensible Markup Language (XML) is a formal recommendation from the World Wide Web Consortium (W3C) of a language for programming Web pages or other structuring of information. The language contains markup symbols to describe the contents of a page, file, or other information. XML describes the content of the page, file, or other information in terms of what data is being described. Therefore, an XML file can be processed purely as data by a program or it can be stored with similar data or it can be displayed. Programming to create the XML document in the step 12 generally follows the formats and arrangement proposed in the formal recommendation to W3C.

In a step 14, object classes are defined. As those skilled in the art will know and appreciate, an object class, in object-oriented programming, is a template definition of the methods and variables in a particular kind of object. The object classes defined in the step 14 are the type-specific objects which are to be instantiated by parsing of the XML document created in the step 12. The object classes are user-designated, according to the user's desired object definitions and the particular object-oriented programming language chosen by the user and the application in which the type-specific objects are to be applied. For example, if the user is programming in the Java™ language, then the object classes will be the user-defined Java™ object classes, and these will be the defined object classes in the step 14. By so defining the object classes in the step 14, the object classes correspond to object classes for other applications (e.g., such as other programs, like a Java™ program), in addition to being type-specific object classes which will be derived from the XML document.

The object classes defined in the step 14 are type-specific object classes. In other words, the object classes so defined in the step 14 are the same object classes that are defined for other applications in object-oriented environments. The object classes defined in the step 14 are, thus, defined as the specific data objects that are desired from the information contained in the XML document. In contrast to past practices, conventionally object classes with respect to XML documents have been generic “Elements”. The generic Elements allow parsing to yield a parse free, distinguishing the outline structure of the XML document. However, such parsing to instantiate generic Elements, does not yield specific data related to the information contents of the XML document. The result is merely generic information about the structure of the XML document, such as page, header, and paragraph outline arrangement (but not the specific, unique information contained in the pages, headers, and paragraphs, or in other specific features of the document). Contrasting the step 14, the object classes defined in the step are type-specific object classes corresponding to type-specific object classes of an object-oriented program or other environment in which specific information contained in the XML document is to be used.

In a step 16, the object classes defined in the step 14 are associated with the XML document. The association in the step 16 maybe by any of a variety of mechanisms for making such association. For instance, a document type definition (DTD) document is often created to accompany XML documents and can be created in a manner so as to provide the object classes association in the step 16. In conventional practices, the DTD is a specification that follows the rules of the Standard Generalized Markup Language (SGML). This DTD specification according to SGML rules accompanies a document and identifies what the codes (or markup) are that generically separate paragraphs, identify topic headings, and other generic features of the document. With respect to conventional creation of XML documents, a DTD has not always been prepared by the XML document creator and, even when it has been prepared, it does not associate type-specific object classes with the documents. The SGML rules do not provide a means to associate type-specific objects.

The Association step 16 of the method 10 associates type-specific object classes (not merely generic classes) with the XML document. The step 16 achieves this because the association made is with and between the type-specific object classes defined in the step 14 and the XML document created in the step 12. It is evident that the conventional DTD specification according to the SGML rules does not provide the type-specific object classes association. However, by extending the DTD specification, in accordance with the present invention, to include some tags or elements representing the desired type-specific object classes from the step 14, the type-specific object classes are associated in the step 16 with the XML document via the representation in the DTD specification for the XML document.

In a step 18, a parse is performed of the XML document having the associated extended DTD specification with elements for type-specific object classes. The parse step 18 may be thought of as (a) performing a parse or break (i.e., 18a) of the parts of the XML document according to the particular type-specific object classes indicated by the associated extended DTD specification and (b) instantiating the type-specific object classes (i.e., 18b) for the data of the XML document. The result of the parse step 18 is, therefore, instantiated type-specific objects from the XML document. The instantiated type-specific objects are useable by other applications in which object-oriented data from the XML document is desired. An example situation in which the instantiated type-specific objects are useable is in a Java™ computer program that operates with the particular information contained in the XML document (not just the outline configuration of the XML document) which has been instantiated through the parse step 18 as the type-specific objects.

Although the association step 16 can be performed as described above using the extended DTD specification, the association step 16 can alternatively be performed in the other manners, such as in stylesheet, in a remote repository, by local class declarations used to override default class declarations, or others. Two particular other possibilities for the association step 16 are embedding of the location of class declarations in the XML document itself or relating to the XML document some relational database containing the location. If the location of class declarations are embedded, the creator of the XML document must, during the step 12 of creating the XML document (or at some other point in modification of the document), incorporate in the XML document itself the tags for the type-specific object classes. One type of tags in XML programming is referred to as XML elements. In the step of creating 12, the programmer creator of the XML document associates the XML element with the type-specific object classes defined in the step 14, for example, a specific Java™ class or another class. In such an instance, the steps 12 and 14 of the method 10 can be reversed in sequence, performed concurrently, or otherwise performed in a manner other than as shown in the sequence of FIG. 1. In any event, the result of the steps 12 and 14 of the method 10 is an XML document that includes XML elements that are associated in the step 16 with type-specific object classes and that ultimately after parsing in the step 18 yield type-specific objects for use in object-oriented programs and environments.

In the second alternative possibility of associating the XML document with some database or other source, for example purposes herein, reference is made particularly to a relational database, the step 16 of associating involves querying the information available in the relational database (or other source, as the case may be). The relational database includes the type-specific object class declarations from the step 14 for associating those classes with the particular information of the XML document, depending on the desired scenario. As referenced herein, the term “class declaration” means any name or locator of the class or the code of the class itself. Where the type-specific object classes are associated with the XML document in such manner, parsing of the XML document according to those classes in the step 18 yields the type-specific objects from the XML document.

Other alternatives for associating in the step 16 the type-specific object classes from the step 14 and the XML document created in the step 12 include specialized files, programs, and other possibilities. Those skilled in the art will know and appreciate the wide variety of alternatives in these regards that are presently or in the future possible, all of which are included in the present invention.

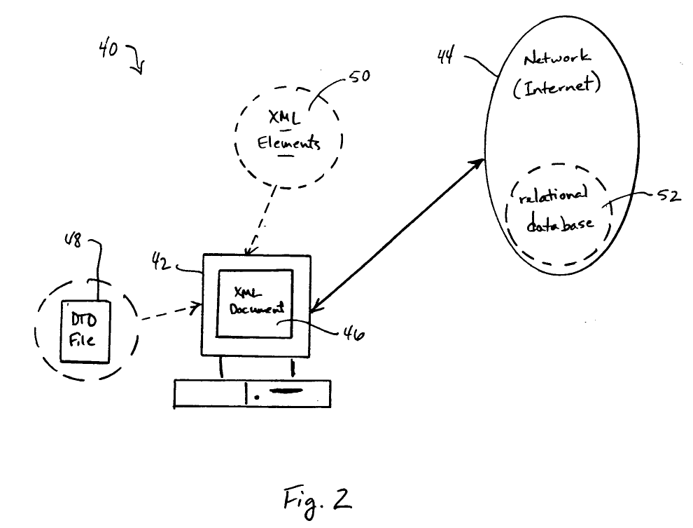

Referring to FIG. 2, a system 40 for performing the method 10 (shown in FIG. 1) includes a computer 42. The computer 42 can be any of a wide variety of types and styles, and the term and identifier “computer”, as used herein, is intended in its broadest sense. For example and for purposes of explanation and description herein, the computer 42 is a personal computer that includes at least a memory, a processor, and a viewing monitor (these elements are commonly known and are not shown in detail). The computer 42 is capable of interpreting XML documents 46 received by or otherwise located at the computer 42.

XML documents can be received by the computer 42 from any of a variety of sources, however, a typical source for such documents, which serves as an example herein, is a network 44, such as the Internet. The network 44 is communicatively connected to the computer 42. The XML documents received by the computer 42 are exemplified in FIG. 2 by the display on the viewing monitor of the computer 42, and are identified as XML document 46.

The XML document 46 is programmed generally in accordance with conventional XML programming practices. In embodiments of the invention in which the type-specific class declarations embedded within the XML document itself, XML elements or tags 50 (exemplified in phantom in FIG. 1, for example) for the type-specific classes are included with the XML document by the programmer. The XML elements 50 may prescribe that on parsing, conversion be made into the type-specific class, for example, a Java™ or other OOPL class type. If the XML parser understands what the XML elements 50 mean or indicate, then the parse is dictated thereby; otherwise, the XML elements 50 are ignored by the parser.

Other embodiments of the invention achieve the type-specific class declarations by extension of the DTD specification made by the programmer for the XML documents 46 of the computer 42. This extension of the DTD specification is exemplified in FIG. 1, in phantom by the DTD file 48. In practice, the DTD file 48 accompanies the XML document 46 at the computer 42. Also, as has been mentioned, embodiments of the invention can also or alternatively achieve the type-specific declarations via use of a relational database 52 (shown in phantom in FIG. 2) that provides the class objects for the XML document 46. The relational database 52 can be located at the computer 42 or otherwise accessible to the computer 42 at another location, for example, internetworked with the computer 42 via the Internet or some other network 44.

In any event in the embodiments of the invention, the type-specific object classes instantiated by parsing of the XML document 46 are provided not by the parser, but instead by a file, database, or other data associated with the XML document 46. As those skilled in the art will know and appreciate, such associated file, database, or other data can be located at and accessible from a wide variety of conventional sources, and future networking and information technology advances will no doubt allow additional and further possibilities for sources of such data. Furthermore, although the foregoing description has primarily addressed concepts in which the type-specific object classes are supplied outside of the XML document 46 and the XML parser themselves, it is possible that the XML document and/or the parser can be hard coded or otherwise programmed or configured in such manner as to provide, at least in part, the desired parsing result and other parts of the desired parsing can be achieved through the concepts herein.

For purposes of illustration and not by way of limitation, the following examples demonstrate possible results and consequences of the invention:

### EXAMPLES

First, an example is presented of a conventional parse of an XML document having the file name donne.xml; then, an example of a type-specific parse of the XML document according to embodiments of the present invention.

Conventional Parse:

When an XML parser generates a parse tree for this document, the resulting tree looks as follows in Lark v.1.0. Lark is a conventional, widely available, non-validating XML parser implemented in the Java™ language. Similar parsers would yield substantially the same parse tree result in conventional operations.

| | | |
|---|---|---|
| root | \|-> Element | \|-> Element \|-> Element |
| | \| | \|-> Element |
| | \| | \|-> Element \|-> Element |
| | \| | |
| | \|->Element | \|-> Element {\|-> Element}* |
| | | \|-> Element {\|-> Element}* |
| | | \|-> Element {\|-> Element}* |
| | | \|-> Element {\|-> Element}* |

The Element entries in the above tree are the objects created by the conventional XML parser, such as the Lark parser. These Element entries correspond to the Element Declarations in the XML document, as conventionally designed. To determine what each Element is, i.e., what is the data content, characteristics, and so forth of the Element, an application operating with the XML document must necessarily navigate the tree structure and inspect each Element object using a generic API. This requires at least that the application have knowledge of how to navigate and operate with the structure. In order for successful navigation, therefore, the application must be coded specifically for navigating and operating with the structure. This is problematic in relation to object-oriented concepts because each and every application that wants to access my such Element object of the XML document will likewise require particular coding that provides the necessary knowledge and navigability of the tree structure. The Element objects of the conventional parse tree of the XML document can, therefore, be considered as “generic” (i.e, rather than “type-specific”) because the objects merely characterize general, structure characteristics of the XML document (i.e., not specific information of characteristics of contents and other details of objects).

With only the generic Element objects of the parse tree resulting from the parse, specific, unique code is required with any application in order to obtain the data information and characteristics of the generic Element objects. For example, merely to retrieve the title of the document requires code something like the following:

```
Element front = null;
Vector v = root.chilren();
if (v != null) {
    Element front = v.elementAt(0); // v(0) “should”
        // be the front element, we hope
    if (front != null)
        v = front. children();
        for (i=0; i < front.size(); i++) {
            Element child = v.elementAt(i);
            if child.type().equals (“title”)
                return child.content();
        }
    }
}
return null;
```

Thus, specific and unique hard-coding in each application is required where use of the XML document information is desired.

Type-Specific Parse:

If the output of the parser was instead a type-specific structure (i.e, rather than merely the generic Element objects of the parse tree above), applications could operate on the type-specific objects, in typical object-oriented fashion, without the necessity of unique and specific hard-coding in applications in order to extract the desired information. Type-specific structure, for example, which coincides with the definition of the structure in the XML document and having resulting objects containing the type-specific behavior for each specific element type parsed, can be achieved from the parse by the methods and systems of embodiments of the invention herein, as shown in the following. The following assumes that the XML document, having file name donne.xml, is a poem, and that the important information and other characteristics of the document which are desirably treated as objects are the general features of any poem, such as the poem itself, the title, author, revision history, stanzas, and so forth.

Within a type-specific parse tree class appropriate to the particular XML document of interest, like a type-specific class poem for purposes of this example, there can be code which understands how to extract the parsed information. (As alternatives to such code, the parser could use separate instantiation directives or other mechanisms, or the parser itself can be extended so that, if there is a one to one correlation of structure between the XML structure and the class structure, then the parser could instantiate it directly. However, only the type-specific class code-based extraction is specifically described in this example.) In effect, the object understands how to investigate itself, so the code can allow desired type-specific (versus generic) extraction via the parse. This code is provided by the object type creator, for example, the creator of the XML document who knows the particular type-specific objects, such as the class poem of the XML document (rather than with generic Element classes as would be extracted from the conventional parse operation), which would be important for other object-oriented applications. The code so created accompanies the object as a means to facilitate re-objectifying the XML back into an object. This enables reuse of the object by any application. The poem class, then, if it is itself instantiated, also provides a poem-specific interface.

In the example, the Element class is related to code created by the object type creator. In this case, the code is exemplified by a method process ( ). The method can be called, i.e., the code is run, once an element has been parsed. In each implementation, for example within the poem class, the process ( ) code handles extracting the data from the inherited generic structures of the Element class. Alternatively, poem methods can simply be written that do this directly. But, it is important to note that the object itself is doing this, and further, that no other parse trees or duplicate structures have been constructed.

In conventional operations, when the parser sees an XML element declaration, the parser instantiates a generic Element object (with Element only related methods). The extension; which calls the coded method process ( ) simply extends the behavior of the the parser so that instead of instantiating generic Element objects, it instantiates type-specific ones. So when the parser encounters a new element declaration, it looks for a class declaration which identifies which class to instantiate in lieu of a generic Element class object. For example, when the parser identifies the “poem” element declaration, it looks for a class declaration for poem. If it finds one, it instantiates an object of that class rather than a generic Element object. The poem class extends the interface of the generic Element class, but in addition, adds type-specific methods relevant to a poem object.

In a particular instance of implementation of the foregoing concept, locations of the class declarations are embedded in the DTD file for the XML document, along with the declaration of the structure of the XML file. In such an instance, one of the class declarations can look like the following for the poem example above (although there are numerous ways, in keeping with the invention, to implement the concept):

| | | |
|---|---|---|
| <!ENTITY | Poem-Class | “http://www.objs.com/xml/poem/com.objs.ia.specification.xml.poem”> |
| <!ENTITY | Font-Class | “http://www.objs.com/xml/poem/com.objs.ia.specification.xml.front”> |
| <!ENTITY | Body-Class | “http://www.objs.com/xml/poem/com.objs.ia.specification.xml.body”> |
| ... | | |

<!ENTITY ClassSuffix “-Class”>

The ClassSuffix is used to avoid possible naming duplications (which may be solved otherwise using the XML namespaces proposal). So, when a new element declaration is identified by the parser, the parser inspects this list looking for an entry matching the pattern <element type><ClassSuffix>, or in the case of the poem element declaration, “Poem-Class”.

The resulting parse tree for the example above would look like:

| | | | |
|---|---|---|---|
| root | \|-> poem | \|-> front | \|-> title |
| | | \| | \|-> author |
| | | \| | \|-> revision-history \|-> item |
| | | \| | |
| | | \|-> body | \|-> stanza |
| | | | \|-> stanza |
| | | | \|-> stanza |
| | | | \|-> stanza |

where poem, front, body, title, author, revision-history, and stanza are all classes with type-specific behavior. Because of the type-specific structure of the parse tree and its elements, one can simply write the following to obtain the object that is the poem title:

poem. getTitle ( );

In this manner, the type-specific parse tree structure, possible because of the association with the XML document of the coded class declarations, provides type-specific behaviors to the data contents of the XML document according to the particular object types that are declared.

It is to be understood that multiple variations, changes and modifications are possible in the aforementioned embodiments of the invention. Although illustrative embodiments of the invention have been shown and described, a wide variety of modification change and substitution is contemplated in the foregoing disclosure and, in some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A method of parsing an XML document, comprising the steps of:
defining type-specific object classes; and
associating the type-specific object classes with the XML document.

2. A system of parsing an XML document, comprising:
a computer capable of receiving the XML document;
a code for operating the computer;
means for calling the code; and
a class declaration locatable by the code.

3. A method of parsing an XML document, comprising the steps of:
acquiring the XML document;
associating the XML document with a call;
calling a code; and
creating a type specific object from the XML document because of the code.

4. A method of generating type-specific objects from XML, comprising the steps of:
calling a code that operates on XML;
processing the code;
locating type-specific class associations;
locating the type-specific class code via the step of processing; acquiring the type-specific class code via the step of processing;
parsing the XML to obtain the type-specific objects, the step of parsing being dictated by the type-specific class declarations from the step of locating and according to a result of the step of processing.

5. A method of generating type-specific objects from a generic object, comprising the steps of:
creating an XML document;
defining type-specific object classes corresponding to the type-specific objects;
associating the type-specific object classes with the XML document;
parsing the XML document to instantiate the type-specific object classes; and
obtaining the type-specific objects.

6. The method of claim 1, wherein the association is selected from the group consisting of explicit association and implicit association.

7. The method of claim 6, wherein the explicit association is by specification via the XML document or a DTD of the XML document.

8. The method of claim 6, wherein the implicit association is by publication of type-specific classes, locators, or links to the Internet, a database, or a query engine.

9. The method of claim 2, wherein the means is associated with XML document.

10. The method of claim 4, wherein the step of parsing is dictated by intelligent parser or a parser that uses instantiation directives.
